(19) United States
(12) Patent Application Publication
(10) Pub. No.: US 2024/0000106 A1
(43) Pub. Date: Jan. 4, 2024

(54) Pet Food and Method of Manufacture

(71) Applicant: Michael Directo, Palm Springs, CA (US)

(72) Inventor: Michael Directo, Palm Springs, CA (US)

(21) Appl. No.: 18/295,724

(22) Filed: Apr. 4, 2023

Related U.S. Application Data
(60) Provisional application No. 63/327,770, filed on Apr. 5, 2022.

(51) Int. Cl. A23K 10/18; A23K 40/25; A23K 50/42; A23K 50/48; A23K 40/10; A23K 20/174; A23K 10/37; A23K 10/35; A23K 10/26; A23K 20/20

(52) U.S. Cl. CPC A23K 10/18; A23K 40/25; A23K 50/42; A23K 50/48; A23K 40/10; A23K 20/174; A23K 10/37; A23K 10/35; A23K 10/26; A23K 20/20

(57) ABSTRACT

The pet food and method of manufacture includes a combination of upcycled ingredients and new ingredients and a careful combination of prebiotics and probiotics to provide pets with a 100% balanced flora. Probiotics, referred to as the “beneficial bacteria,” and prebiotics, referred to as the “beneficial fiber” work together to stabilize a pet's digestive system, promote good bacteria growth, and a healthy immune system.

### RELATED APPLICATION

This application claims priority to U.S. Provisional Patent Application Ser. No. 63/327,770 for “Pet Food and Method of Manufacture,” filed Apr. 5, 2022, and currently co-pending, the entirety of which is incorporated herein by reference.

### FIELD OF THE INVENTION

The present invention pertains generally to pet foods. More particularly, the present invention pertains to a Pet Food And Method Of Manufacture. The Present invention is particularly, but not exclusively, useful as Pet Food And Method Of Manufacture having a combination of probiotics, prebiotics and upcycled food components.

### BACKGROUND OF THE INVENTION

Pet food varies with the type of animal kept as a pet. Dogs and cats, which are among the most common pets kept in the United States, are generally fed kibble, often referred to as “dry food,” or canned “wet food.” Pet owners also often provide pet treats to their animals, for encouragement during training, for rewards for good behavior, and sometimes just for a treat.

Pet foods typically include ingredients such as cereals, which are basic carbohydrates like grain, rice bran, and beet pulp, vegetables, fish, chicken and beef, which provide both protein and calcium, fats and oils, and a source for vitamins and the energy that animals need to survive. These ingredients are generally available in solid form, such as kibble, or in wetted form, such as a canned food product. In either case, the product is preserved and stabilized for shelf life, and distributed through large networks to retail establishments or through direct-to-consumer channels.

While the various pet food products are generally wholesome, and rather well tolerated by most pets, these products fail to take into account the gut health of the animals. Our pets' stomachs are incredible food processors. They convert the nutrients they need into fuel and get rid of everything else. However, without a proper balanced gut biome, this complex processing system can breakdown and lead to some of the most common pet ailments: skin and coat Issues, flatulence (gas), poor gut health, bloating, and inflammation. Unfortunately, the general nature of the large pet food producers makes it rather difficult to obtain a pet food for an animal having a particular intolerance for the pet food's ingredients.

In addition to the health challenges some pets experience based on interactions with their available food options, 1.3 billion tons of food is wasted every year. This wasted food would be enough to feed roughly 3 billion people, and countless more animals if it were repurposed for that use.

In light of the above, it would be advantageous to provide a pet food solution that could be treated to encourage and facilitate animal gut health. It would be further advantageous to provide a pet food solution that would encourage the development of healthy bacteria within the digestive system, and to provide pets with a palatable food and treat option. It would be additionally advantageous to provide an assortment of dry and wet pet foods and pet treats to provide pets with a healthy alternative to the currently available large scale manufactured food options.

### SUMMARY OF THE INVENTION

Disclosed is a pet food and method of manufacture. A preferred embodiment is particularly useful for providing pets a food and treat source that facilitates gut health, and is both economically reasonable and environmentally positive. In a preferred embodiment, rescued unused, imperfect, and irregular food products are collected and prevented from being discarded. These food products are then transformed into one-of-a-kind pet treats, pet foods and even a litter.

The basic pet food of the pet food and method of manufacture includes a combination of upcycled ingredients and new ingredients. In addition to these ingredients, a key feature of the pet food and method of manufacture of the present invention is a careful combination of prebiotics and probiotics to provide pets with a 100% balanced flora. Probiotics, also referred to as the “beneficial bacteria” helps to bring balance and order to a pet's belly. Studies have shown that adding live bacteria like Lactobacillus acidophilus and Lactobacillus casei to a pet's diet can help increase the good bacteria. All while keeping the bad bacteria at bay. Prebiotics, also referred to as the “beneficial fiber” ferment in the pet's digestive track and become food for probiotics, and are naturally found in foods like inulin, chicory root, kimchi, and kombucha, sundried kelp. Also, the pet food and method of manufacture can include pre and postbiotics made from natural fermenting yeasts that promote good bacteria growth and a healthy immune system.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a method diagram outlining the components and method of manufacturing the pet food and method of manufacture of the present invention for the prebiotic component and identifies typical upcycled ingredients, new ingredients, and their combination, mixing, and mechanical processing into three distinct products including dry pet food, wet pet food, and a meal enhancement; and

FIG. 2 is a method diagram outlining the components and method of manufacturing the pet food and method of manufacture of the present invention for the probiotic component and identifies typical upcycled ingredients, new ingredients, and their combination, mixing, and mechanical processing into pet treat products including the addition of probiotics before, or after, or both before and after, the baking stage of the process.

### DETAILED DESCRIPTION

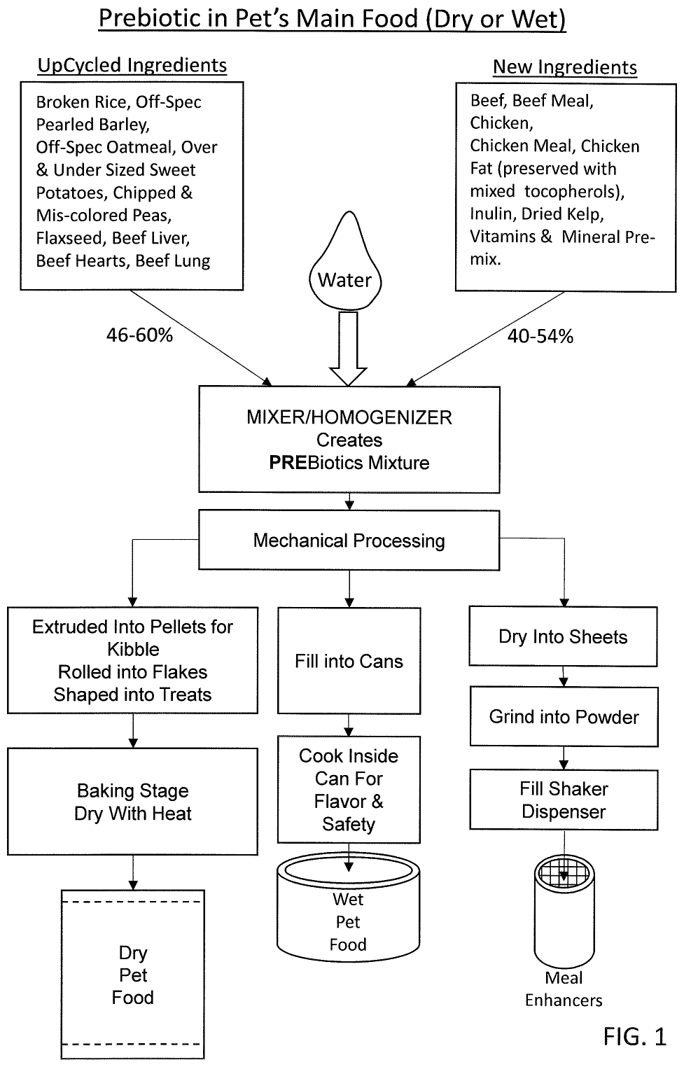

Referring initially to FIG. 1, a method diagram outlining manufacturing the prebiotic portion of the pet food and method of manufacture of the present invention is generally designated 100. Method 100 includes the identification of upcycled ingredients 102 suitable for use in pet products, and can include broken rice, off-spec pearled barley, off-spec oatmeal, over and under sized sweet potatoes, chipped and mis-colored peas, flaxseed, beef Liver, beef hearts, and beef lung. The list of upcycled ingredients is merely exemplary and not intended to place a limitation of the use of upcycled food products in the pet products of the present invention.

“Off-spec” as used herein is intended to refer to those products which, due to cosmetics, size or damage, are not considered prime products suitable for human sale and consumption. It is these off-spec food products which are often discarded to the landfill, fertilizer, or other wasteful misuse.

A list of new ingredients 104 is provided and includes beef, beef meal, chicken, chicken meal, chicken fat (preserved with mixed tocopherols), inulin, dried kelp, vitamins and a mineral pre-mix. Similarly, the list of new ingredients is merely exemplary and not intended to place a limitation on the use of new food products in the pet products of the present invention. In addition to the upcycled ingredients 102 and the new ingredients 104, water 106 is added.

The ratios of the upcycled ingredients 102, the new ingredients 104 and water 106 are defined in ratios 108, 110, and 112, respectively. In a preferred embodiment, the upcycled ingredients range from about 46 to 60 percent of the ingredients, and the new ingredients range from about 40 to 54 percent of the ingredients with water being added to facilitate mixing and blending.

The upcycled ingredients, new ingredients and water are all mixed in the Mixer/Homogenizer block 114 in which the ingredients are blended and integrated together to create a prebiotics mixture. This prebiotics mixture is then provided to block 116 for mechanical processing. One mechanical processing is the start of the dry pet food products along path 118. Specifically, in step 120, the mixture is extruded into pellets for kibble, rolled into flakes, or shaped into treats. Once processed, the post-processed prebiotics mixture is then dried in baking stage 122. Once appropriately baked, the now dried prebiotics mixture is packaged into a dry pet food container 124, such as a bag, box, or carton.

As an alternative to step 120 is path 126 in which the prebiotics mixture is filled into cans in step 128, and then the cans are sealed and cooked in step 130 which provides both flavor and safety for the prebiotics pet food. The prebiotics food is then provided in a wet pet food product 132, such as a sealed aluminum can.

As another alternative to steps 120 and 128, the prebiotics mixture follows path 134 where it is placed to dry in sheets in step 136. Once dry, the sheets of step 136 where it is ground into powder in step 138. This ground prebiotics powder is then used to fill a shaker dispenser in step 140 to be provided as a mean enhancer product 142. In use, a meal enhancer product would be used to sprinkle a bit of prebiotics over the top of a non-prebiotics pet food so as to provide some of the benefits of a prebiotic to a pet.

It is to be appreciated that the mechanical processing that is described herein is merely indicative of a preferred embodiment of the pet food and method of manufacture of the present invention. There are a variety of other mechanical processing options which are known in the art, and within the scope of the present invention.

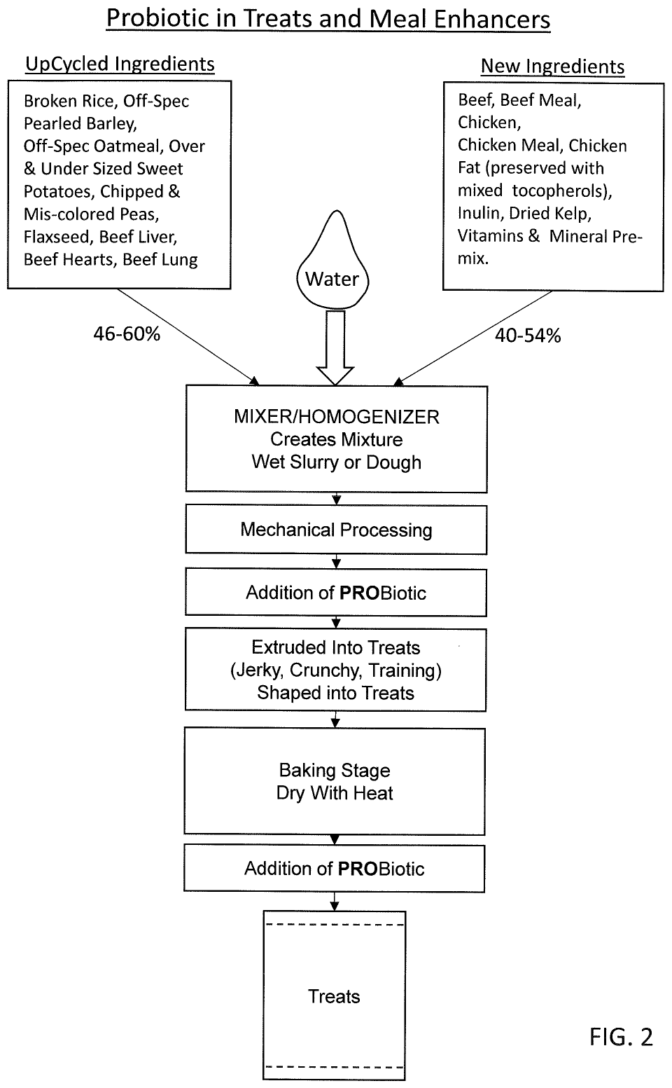

Referring now to FIG. 2, a method diagram outlining manufacturing the probiotics portion of the pet food and method of manufacture of the present invention is generally designated 200. Method 200 includes the identification of upcycled ingredients 202 suitable for use in pet products, and can include broken rice, off-spec pearled barley, off-spec oatmeal, over and under sized sweet potatoes, chipped and mis-colored peas, flaxseed, beef Liver, beef hearts, and beef lung. Again, the list of upcycled ingredients is merely exemplary and not intended to place a limitation of the use of upcycled food products in the pet products of the present invention.

A list of new ingredients 204 is provided and includes beef, beef meal, chicken, chicken meal, chicken fat (preserved with mixed tocopherols), inulin, dried kelp, vitamins and a mineral pre-mix. Similarly, the list of new ingredients is merely exemplary and not intended to place a limitation on the use of new food products in the pet products of the present invention. In addition to the upcycled ingredients 202 and the new ingredients 204, water 206 is added.

The ratios of the upcycled ingredients 202, the new ingredients 204 and water 206 are defined in ratios 208, 210, and 212, respectively. In a preferred embodiment, the upcycled ingredients range from about 46 to 60 percent of the ingredients, and the new ingredients range from about 40 to 54 percent of the ingredients with water being added to facilitate mixing and blending.

The upcycled ingredients, new ingredients and water are all mixed in the Mixer/Homogenizer block 214 in which the ingredients are blended and integrated together to create a probiotics wet slurry or dough. Once the probiotics mixture is made in step 214, mixture is then provided to block 116 for mechanical processing.

As a part of the mechanical processing, probiotics may be added to the mixture at the time the mixture is still in a larger volume, such as before it is processed into specific food items. This is particularly useful when using probiotics which are capable of surviving through the baking, or drying stage discussed below. Some probiotics are not capable of withstanding the heat of a baking or drying cycle, and thus must be applied later as will be discussed below.

Once the probiotics mixture is processed, it is then formed into the final food product shape in step 220, such as extrusion into treats such as jerky, crunchy, or training bites, or otherwise shaped into treats. The shape of the treats, while aesthetically appealing to the consumer, has little or nothing to do with the efficacy of the probiotics in the food product.

Once finally formed into the pet food product in step 220, the probiotics mixture is then dried in the baking stage in step 222. Following the drying process, the probiotic food product may then be treated with a probiotic. More specifically, if using probiotics may be tolerant of a heated baking cycle, they may have been added in step 218. However, some probiotics are not capable of withstanding the heat. Thus, if applying probiotics that are not heat-tolerant, they are applied in step 224. It is to be appreciated that the addition of probiotics is not necessarily exclusive of step 218 or step 224. Probiotics could in fact be applied in both steps.

Once the probiotics mixture has been processed as outlined above, it is then packaged for distribution, such as in treat bags 226. It is also to be appreciated that treat bags 226 are not the exclusive method of distribution, and they treats may be packaged and distributed in bulk, in small packages, or larger packages.

In a preferred embodiment of the present invention, dry dog food with prebiotics will include Beef, Chicken and Turkey in a variety of bag sizes, and wet cat food with prebiotics will include three proteins chicken, tuna, mackerel in convenient cans, as well as a variety of meal enhancement flavors. Other animals may use the pet food described herein. Coupled to the prebiotics, a variety of probiotic pet treats will be provided in a variety of flavors and shapes to accommodate the pet-owners' lifestyle. The integration of the prebiotics and probiotics pet food products into products that pet owners use every day, encourages a balanced microbiome which supports shiny coats, healthy skin and better digestion so that the digestive track health, and the overall health of the pet, will be improved.

While there have been shown what are presently considered to be preferred embodiments of the present invention, it will be apparent to those skilled in the art that various changes and modifications can be made herein without departing from the scope and spirit of the invention.

What is claimed is:

1. A pet food product, comprising:
a prebiotic component, comprising:
one or more upcycled ingredients, and
one or more new ingredients,
wherein the one or more upcycled ingredients and the one or more new ingredients are mixed at a predetermined ratio and mechanically processed to form a food item; and
a probiotic component, comprising:
one or more upcycled ingredients,
one or more new ingredients, and
probiotic ingredients,
wherein the one or more upcycled ingredients and the one or more new ingredients are mixed at a predetermined ratio, mechanically processed, and added to the probiotic ingredients to form a supplementary food item.

2. The pet food product of claim 1, wherein the prebiotic component is extruded into pellets and baked so that the food item is dry pet food.

3. The pet food product of claim 1, wherein the prebiotic component is placed into a can and cooked so that the food item is wet pet food.

4. The pet food product of claim 1, wherein the prebiotic component is dried into sheets, grinded into powder, and placed into a dispenser so that the food item is a meal enhancer.

5. The pet food product of claim 1, wherein the new ingredients of the prebiotic component comprise a vitamin and mineral premix.

6. The pet food product of claim 1, wherein the probiotic component is shaped into treats and baked prior to addition of the probiotic ingredients.

7. The pet food product of claim 1, wherein the probiotic component is shaped into treats and baked after addition of the probiotic ingredients.

8. The pet food product of claim 7, wherein the probiotic component further comprises additional probiotic ingredients added after baking.

9. The pet food product of claim 1, wherein the new ingredients of the probiotic component comprise a vitamin and mineral premix.

10. A method of pet food manufacture, comprising the steps of:
providing upcycled ingredients;
providing new ingredients;
mixing the upcycled ingredients and the new ingredients at a predetermined ratio and adding water to create a prebiotics mixture; and
mechanically processing the prebiotics mixture to create a food item.

11. The method of claim 10, wherein the upcycled ingredients comprise one or more of:
broken rice;
off-spec pearled barley;
oversized sweet potatoes;
undersized sweet potatoes;
chipped and miscolored peas;
flaxseed;
beef liver;
beef hearts; and
beef lung.

12. The method of claim 11, wherein the new ingredients comprise one or more of:
beef;
beef meal;
chicken;
chicken meal;
chicken fat;
inulin;
dried kelp; and
a vitamins and mineral premix.

13. The method of claim 10, further comprising the steps of:
extruding the mixture into pellets for kibble; and
baking the extruded pellets,
whereby the food item is a dry pet food.

14. The method of claim 10, further comprising the steps of:
placing the mixture into cans; and
cooking the canned mixture inside the cans,
whereby the food item is a wet pet food.

15. The method of claim 10, further comprising the steps of:
drying the mixture into sheets;
grinding the sheets into powder; and
placing the powder into dispensers,
whereby the food item is a meal enhancer.

16. A method of pet food manufacture, comprising the steps of:
providing upcycled ingredients;
providing new ingredients;
mixing the upcycled ingredients and the new ingredients at a predetermined ratio and adding water to create a mixture comprising a wet slurry or dough;
mechanically processing the mixture;
shaping the mixture into treats; and
baking the mixture,
wherein the method further comprises the step of adding probiotics.

17. The method of claim 16, wherein the step of adding probiotics is performed before the step of shaping the mixture into treats.

18. The method of claim 16, wherein the step of adding probiotics is performed after the step of baking the mixture.

19. The method of claim 16, wherein the step of adding probiotics is performed before the step of shaping the mixture into treats, and wherein a step of adding additional probiotics is performed after the step of baking the mixture.

20. The method of claim 16, wherein the new ingredients comprise a vitamin and mineral premix.
